(19) United States
(12) Patent Application Publication
(10) Pub. No.: US 2004/0094939 A1
(43) Pub. Date: May 20, 2004

(54) Assembly consisting of a vehicle body part and of a gas bag module

(75) Inventors: Jens Debler, Schwabisch Gmund (DE); Joachim Lutz, Schechingen (DE); Dirk Schultz, Heubach (DE)

Correspondence Address: TAROLLI, SUNDHEIM, COVELL, TUMMINO & SZABO L.L.P., 1111 LEADER BLDG., 526 SUPERIOR AVENUE, CLEVELAND, OH, 44114-1400, US

(73) Assignee: TRW Occupant Restraint Systems GmbH & Co. KG

(21) Appl. No.: 10/699,754

(22) Filed: Nov. 3, 2003

(30) Foreign Application Priority Data
Nov. 15, 2002 (DE) 102 53 403.9

(51) Int. Cl. B60R 21/16

(52) U.S. Cl. 280/732

(57) ABSTRACT

An assembly consists of a gas bag module (16; 16′; 116; 216; 316; 416; 516; 616) and a vehicle body part (10; 510) including a ventilation channel (34; 134; 234; 334; 434; 534; 634) for ventilating a front windscreen. The ventilation channel is arranged between the front windscreen (12; 112; 212; 312; 412; 512; 612) and the gas bag module. The gas bag module (16; 16′; 116; 216; 316; 416; 516; 616) has a gas bag (52; 52′; 52″; 152; 252; 352; 452; 552; 652) folded to form a gas bag package and a gas lance (54; 54′; 54″; 154; 254; 354; 454; 554; 454″; 654) through which gas can be directed into the gas bag. The gas bag module has an ejection opening (50; 50′; 50″; 150; 250; 350; 450) through which the gas bag can be ejected on inflation. The gas bag package comprises first and second partial packages, of which the first partial package (52a; 152a; 252a; 352a; 452a; 552a; 652a) is arranged closer to the ejection opening, whereas the second partial package (52b; 152b; 252b; 352b; 452b; 552b; 652b) is arranged further away with respect to the ejection opening. The gas lance (54; 54′; 54″; 154; 154″; 254; 354; 454; 554; 454″; 654) is arranged in the gas bag module such that only the first partial package (52a; 152a; 252a; 352a; 452a; 552a; 652a) is situated between the ejection opening (50; 50′; 50″; 150; 250; 350; 450) and the gas lance.

### TECHNICAL FIELD

The invention relates to an assembly consisting of a gas bag module and of a vehicle body part.

### BACKGROUND OF THE INVENTION

Such assemblies typically include a ventilation channel for ventilating a front windscreen, the ventilation channel being arranged between the front windscreen and the gas bag module, the gas bag module having a gas bag folded to form a gas bag package, and a gas lance through which gas can be directed into the gas bag, the gasbag module having an ejection opening through which the gas bag can be ejected on inflation.

Gas bags are intended to protect a vehicle occupant from ungentle contact with the structure of the vehicle by taking up his kinetic energy and substantially effectively braking his head. This requirement can not be fulfilled easily in particular when the vehicle occupant is not in an optimum sitting position, i.e. when he is bending his upper body forward or to the side. In such cases, the gas bag must unfold as far away as possible from the occupant on a broad front, in order to be able to intercept the occupant in various positions. This is achieved in prior art by an elongated gas bag module which extends parallel to the front edge of the instrument panel, as is described for example in the DE 23 38 025.

It is an object of the invention to provide an assembly of the type initially mentioned, in which the gas bag module is arranged as far away as possible from the vehicle occupant and which allows a gentle and mild unfolding of the gas bag on a broad front.

### BRIEF SUMMARY OF THE INVENTION

According to the invention, an assembly comprises a gas bag module and a vehicle body part including a ventilation channel for ventilating a front windscreen. The ventilation channel is arranged between the front windscreen and the gas bag module. The gas bag module has a gas bag folded to form a gas bag package and a gas lance through which gas can be directed into the gas bag. The gas bag module has an ejection opening through which the gas bag can be ejected on inflation. The gas bag package comprises first and second partial packages, of which the first partial package is arranged closer to the ejection opening, whereas the second partial package is arranged further away with respect to the ejection opening. The gas lance is arranged in the gas bag module such that only the first partial package is situated between the ejection opening and the gas lance. On inflation of the folded gas bag by the gas lance, firstly only the first partial package is ejected. The folded layers of the remaining partial package are drawn along in the further course of the inflation process. As not the entire mass of the gas bag in a package is in motion, the stress in particular for the front windscreen is also reduced and therefore a gentler ejection of the gas bag is ensured. Also, a more uniform unfolding of the gas bag can be achieved in this way.

According to an advantageous embodiment of the invention, the first partial package is folded in a first manner and the second partial package is folded in a second manner. The types of folding of the partial packages can be adapted for example in that the first partial package can be unfolded more simply outside the ejection channel, whereas the second partial package can be unfolded more simply within the housing, so that the layers can be drawn out from the housing in succession. Therefore, a particularly uniform and gentle unfolding of the gas bag can be achieved.

Further advantageous developments of the invention will be apparent from the sub-claims.

### BRIEF DESCRIPTION OF THE DRAWINGS

FIG. 1 shows a cross-section through an assembly according to a first embodiment of the invention;

FIG. 2 shows an enlarged illustration of region II of FIG. 1;

FIG. 3 shows a cross-section through an assembly according to a second embodiment of the invention;

FIG. 4 shows a perspective view of the gas bag module of the assembly of FIG. 3;

FIG. 5 shows a view of a first type of construction of a gas lance of a gas bag module for an assembly according to the invention;

FIG. 6 shows a cross-section through an assembly according to a third embodiment of the invention;

FIG. 7 shows a cross-section through an assembly according to a fourth embodiment of the invention;

FIG. 8 shows a perspective view of the gas bag module of the assembly of FIG. 7;

FIG. 9 shows a cross-section through an assembly according to a fifth embodiment of the invention;

FIG. 10 shows a perspective view of the gas bag module of the assembly of FIG. 9;

FIG. 11 shows a cross-section through an assembly according to a sixth embodiment of the invention;

FIG. 12 shows a diagrammatic view of the assembly of FIG. 1;

FIG. 13 shows a cross-section through a second type of construction of a gas lance of a gas bag module for an assembly according to the invention;

FIG. 14 shows a cross-section through a third type of construction of a gas lance of a gas bag module for an assembly according to the invention;

FIG. 15 shows a cross-section through a fourth type of construction of a gas lance of a gas bag module for an assembly according to the invention;

FIG. 16 shows a cross-section through a gas bag module of an assembly according to a seventh embodiment of the invention;

FIG. 17 shows a cross-section through a gas bag module of an assembly according to an eighth embodiment of the invention;

FIG. 18 shows a cross-section through an assembly according to a ninth embodiment of the invention;

FIG. 19 shows a cross-section through an assembly according to a tenth embodiment of the invention;

FIG. 20 shows a type of construction of a gas bag module for an assembly according to the invention with a connected gas generator; and

FIG. 21 shows a view of the gas generator and of the connecting clip of the gas bag module of FIG. 21.

### DETAILED DESCRIPTION OF THE PREFERRED EMBODIMENTS

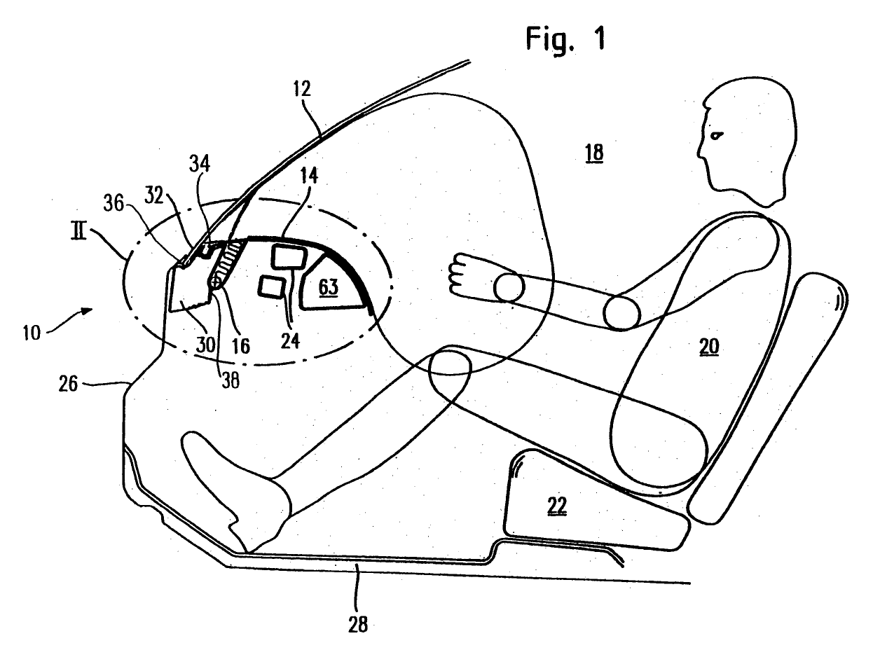

In FIG. 1 an assembly is shown in cross-section diagrammatically, which consists of a part of a vehicle body 10 with a front windscreen 12 and an instrument panel 14 and of a gas bag module 16. The vehicle body surrounds a vehicle interior 18 in which a vehicle occupant 20, who is indicated diagrammatically in FIG. 1, can stay for example sitting on a seat 22. The vehicle body part 10 has frame supports 24, a splashboard 26 and a vehicle floor 28. The vehicle body part 10 also comprises a pane fixture 30 in which the front windscreen 12 is mounted with its lower edge 32. Starting from the pane fixture 30, the instrument panel 14 extends into the vehicle interior 18, whereby it conceals the pane fixture 30 and the frame support 24 from being seen by the vehicle occupant 20.

The pane fixture 30 may for example be constructed as a hollow section of plastic or metal, as illustrated in the figures. On its side facing away from the vehicle interior 18, an indentation 36 is formed to receive the lower edge 32 of the front windscreen 12. In the pane fixture 30 there is space in addition for a ventilation channel 34, by means of which warm air can be directed to the front windscreen 12 in order to de-ice it or to prevent it from showing condensation. On the inner side 38 of the pane fixture 30 pointing towards the vehicle interior 18, the gas bag module 16 is arranged, various types of construction of which are illustrated in greater detail in the further figures.

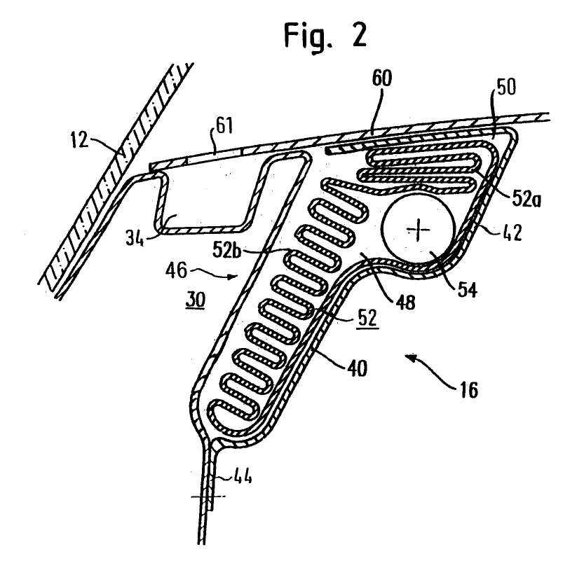

The gas bag module illustrated in FIG. 2 has a housing 40 which has a narrow, substantially rectangular cross-section. At the lower end of the housing in the installed state, there is a fastening section 44. The housing 40 is fastened to the pane fixture 30 by this fastening section 44. The housing forms an ejection channel 48 which is delimited by a first ejection channel wall 42 and a second ejection channel wall 46. The ejection channel 48 opens out into an ejection opening 50, and its cross-section is widened at the upper end. A gas bag 52, accommodated in the housing, can be ejected through the ejection opening 50. A gas lance 54 serves to introduce compressed gas into the interior of the gas bag 52 in order to inflate it. The gas bag is folded into two partial packages, namely a first partial package 52a which is situated between the ejection opening and the gas lance, and a second partial package 52b which is accommodated in the lower part of the housing 40.

The length of the gas bag module is defined as the dimension which is measured along the extent of the gas lance, i.e. in the drawing perpendicular to the illustrated cross-section. The width of the module is defined as the dimension transverse to the length, substantially parallel to a plane formed by the ejection opening. The height of the module, finally, is defined as the dimension which is measured substantially perpendicular to the plane of the ejection opening.

Advantageously, the first partial package 52a of the gas bag 52 only comprises a few layers and is therefore smaller than the second partial package 52b. Through this arrangement, it is achieved that on activating the gas bag module 16, firstly the few layers of the upper partial package 52a are ejected in the direction of the front windscreen 12 and thereafter the remaining layers of the lower partial package 52b are drawn along by the unfolding gas bag 52, the gas bag 52 being able to unfold in an advantageous manner along the front windscreen 12. As it is not the entire gas bag which is ejected in one package, the stress on the front windscreen is reduced and a uniform and gentle unfolding of the gas bag is ensured.

The two partial packages 52a and 52b can be folded in different ways, for example such that the first partial package 52a can unfold outside the housing in a particularly favourable manner, whereas the type of folding of the second partial package facilitates the drawing along of the remaining gas bag in layers.

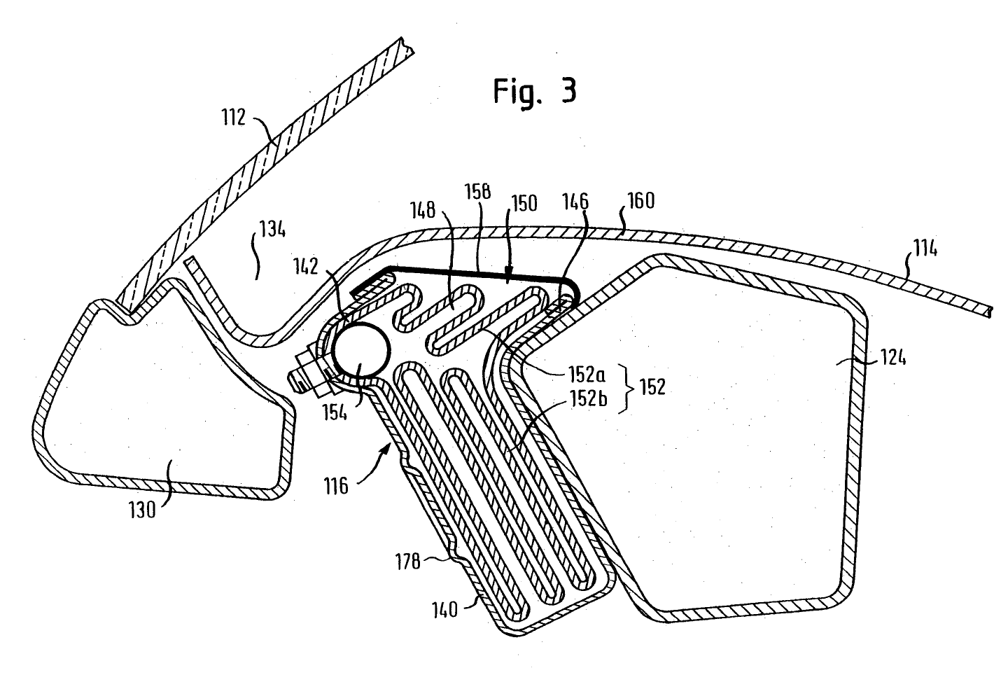

In the region of the gas bag module 16, the instrument panel 14 forms a covering 60 for the ejection opening 50. In the covering 60, in a known manner a nominal fracture point or tear line can be provided, which in the case of activation permits a tearing open of the covering 60 and the emergence of the gas bag 52 from the ejection channel 48. Alternatively, the covering 60 can also be integrated into the housing 40 of the gas bag module or into the ventilation channel 34. In the covering 60, in so far as it also covers the ventilation channel 34, ventilation openings 61 can also be constructed, through which the air can escape from the ventilation channel 34. Between the gas bag module 16 and the front windscreen 12, the ventilation channel 34 is situated, which is integrated into the pane fixture 30. Alternatively, the ventilation channel can also be integrated into the covering 60 (FIG. 3) or constructed as a separate part.

As can be seen clearly in FIG. 12, the gas bag module 16, owing to its elongated and narrow construction, can be arranged close enough to the front windscreen 12, so that the moving parts of the opening mechanism of the gas bag module 16, i.e. the tearing open covering 60, lie far away from the interaction area of the vehicle occupant 20, even when he is bending forward, in order for example to reach into a glove compartment 63. The elongated construction already ensures an unfolding of the gas bag on a wide front in the initial phase.

Advantageously the gas bag module 16 is curved in accordance with the shape of the vehicle body part 10, as can be seen for example in FIGS. 10, 11, 12 and 16. The curvature can be adapted in particular to the path of the lower edge 32 of the front windscreen 12, so that the gas bag module 16 can run as closely as possible along the ventilation channel 34 or pane fixture 30, these being able to form the second ejection channel wall 46 for the gas bag module 16. In addition, the gas bag module 16 can be advantageously adapted by the curvature to the design of the instrument panel 14.

In FIG. 3 a second embodiment of the invention is shown, in which reference numbers increased by 100 are used for components which are already known.

In this embodiment, the gas bag module 116 is fastened to a frame support 124 of the vehicle. The gas bag module 116 has an angled ejection channel 148; the ejection channel 148 extends in a direction different from the remaining part of the housing 140, in which the larger gas bag partial package 152b is arranged. The angled ejection channel 148 makes provision that the gas bag is ejected substantially parallel to the front windscreen 112, in order to reduce its stress and to ensure a faster unfolding of the gas bag in the direction to the vehicle occupant. Nevertheless, the gas bag module 116 can be installed close to the front windscreen 112, i.e. to the pane fixture 130, because through the angled shape of the ejection channel 148 the majority of the gas bag module 116 can be accommodated between the pane fixture 130 and the frame support 124.

For simpler installation and to protect the gas bag 152, the folded gas bag package 152a can be covered with a protective layer 158 which extends for example in the form of a foil or a fabric layer between the edges of the ejection opening 150 and can be provided with a perforation in order to facilitate the tearing open of the protective layer 158.

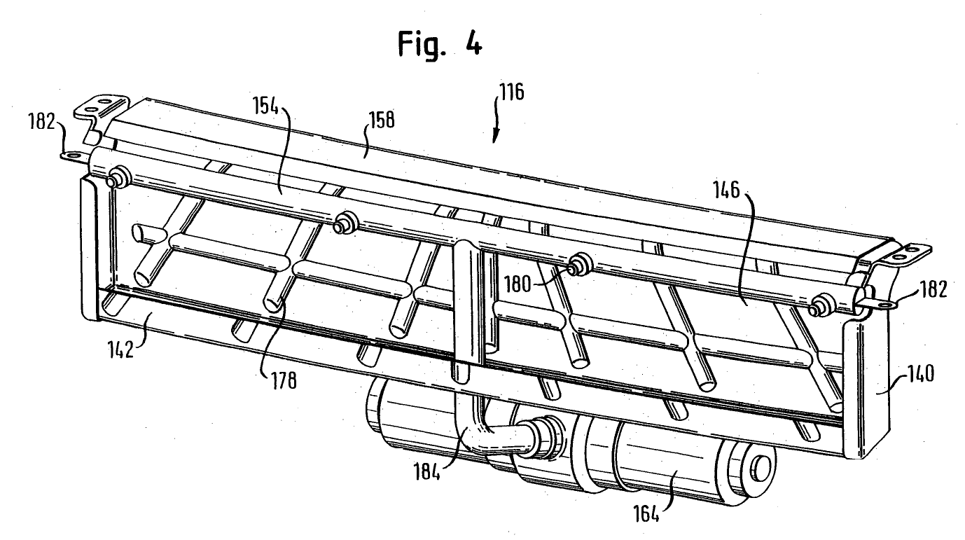

In FIG. 4 this gas bag module 116 is illustrated in a perspective view. In this embodiment, the housing 140 is joined together from wall pieces, e.g. of plastic or sheet metal, the parts having a large area, which form the two ejection channel walls 142, 146, being provided with beads 178 for reinforcement. The first, rear ejection channel wall 142 is cut open in the illustration in FIG. 4, so that the gas lance 154 can be readily seen. The gas lance 154 extends over the entire length of the module 116 and is provided with fastening pins 180 by which it can be fastened in the housing 140 e.g. on the rear ejection channel wall 142. At the ends of the gas lance 154 which project from the housing 140, fastening tongues 182 can be constructed for additional fastening in the vehicle. From the center of the gas lance 154, a connecting tube 184 leads to a gas generator 164 which is accommodated outside the module 116 in the vehicle. The connecting tube 184 is connected to the gas generator 164 by means of a detachable connection 186, which is described further below, so that the gas generator 164 can also be installed easily after installation of the gas bag module 116 and can be exchanged, if necessary. The connecting tube 184 also makes possible in an advantageous manner the housing of the gas generator 164 independently of the module 116 at a suitable site in the vehicle.

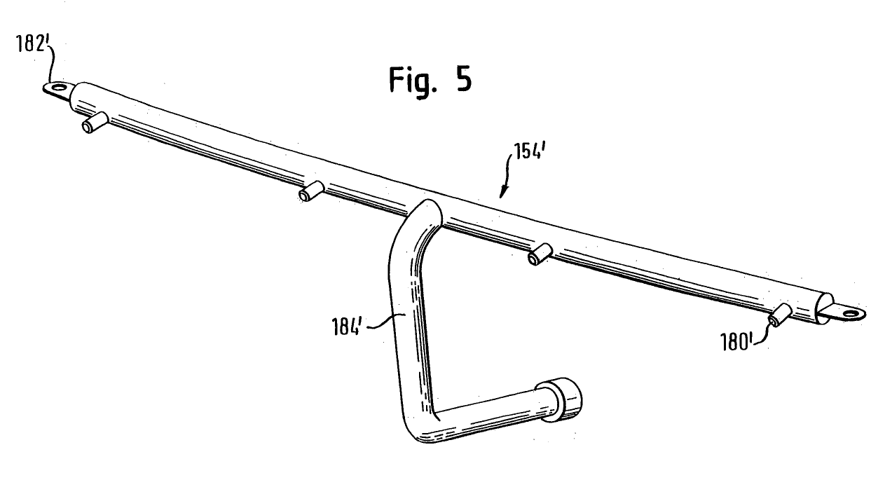

A variant for the design of a gas lance 154′ with connecting tube 184′ can be seen in FIG. 5. Here, the connecting tube 184′ projects parallel to the fastening pins 180′ out from the gas lance 154′ and is curved through approximately 90 degrees in the immediate vicinity of its connection to the gas lance 154′. Thereby, it can largely be guided outside the housing 140′, whereby more space remains available in the housing 140′ to accommodate a gas bag, or the housing can be smaller.

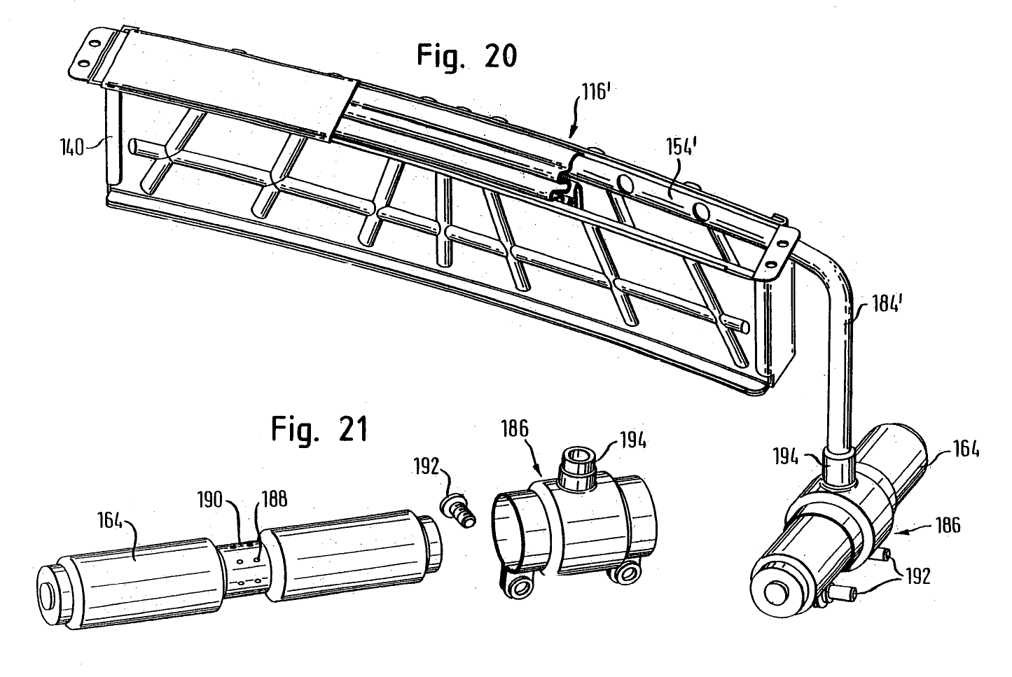

The T-shaped arrangement of the connecting tube 184 in the center of the gas lance 154 produces a symmetrical flow path on inflow of the gas. Thereby, it is advantageously avoided that the inflowing gas exerts a thrust force in longitudinal direction onto the gas lance 154. The connecting tube 184 can alternatively also be arranged on an end of the gas lance 154″, or can be brought as an extension thereof out from the housing 140″, as shown in FIG. 20.

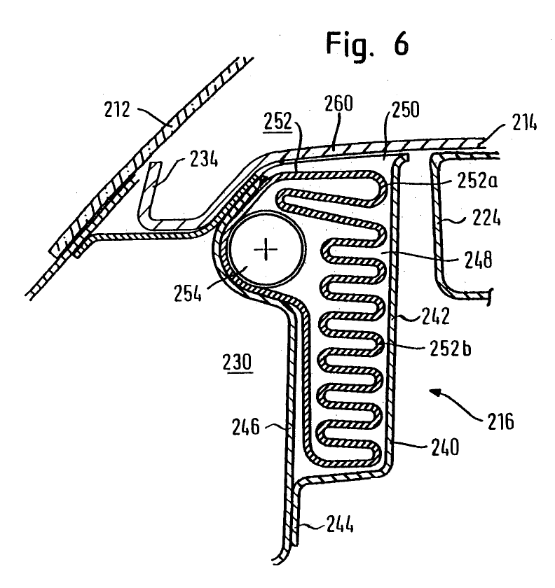

In a third embodiment of the invention, which is shown in FIG. 6 with reference numbers starting from 200, the gas bag module 216 is again fastened to the pane fixture 230. The housing 240 and in particular the ejection channel 248 in this embodiment, in contrast to the embodiments previously described, stands substantially in the vertical and therefore follows the geometric characteristics of the vehicle structure which are given by the pane fixture 230. The gas lance 254 is arranged here on the side of the gas bag module 216 pointing towards the front windscreen 212. Thereby, the gas bag 252 is not ejected in the direction of the transverse axis of the ejection channel 248 on inflation, but rather it receives a deflecting impulse, so that it can spread out substantially parallel to the front windscreen 212.

The ejection channel 248 is delimited by a first ejection channel wall 242, which is formed by the housing 240 of the gas bag module 216, and by a second ejection channel wall 246 which is formed by the frame support 224. Therefore, one wall can be spared on the housing 240, whereby a saving on weight and cost results for the gas bag module 216.

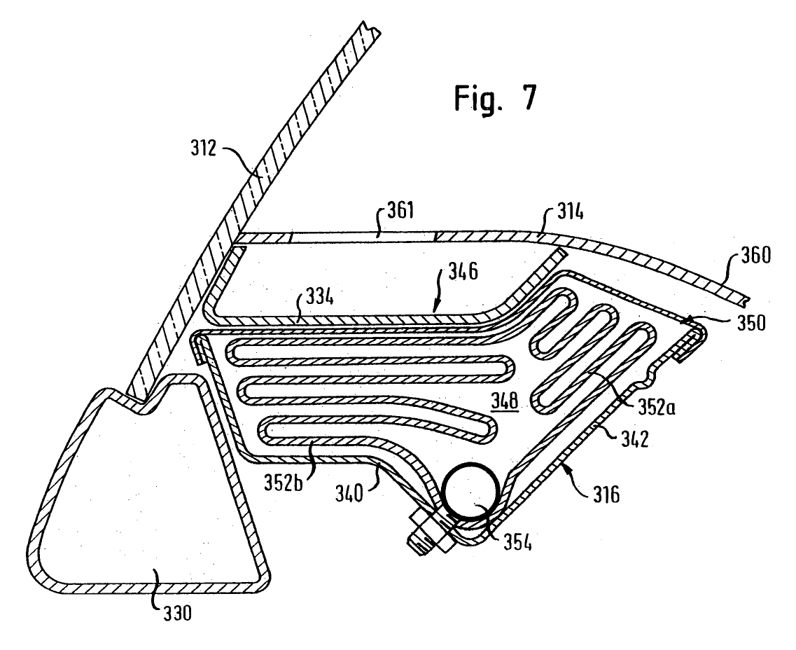

A fourth embodiment which is illustrated in FIG. 7 and is provided with reference numbers starting from 300, has a gas bag module 316 with an angled ejection channel 348 which is arranged under the ventilation channel 334. The ventilation channel 334 replaces the second ejection channel wall 346.

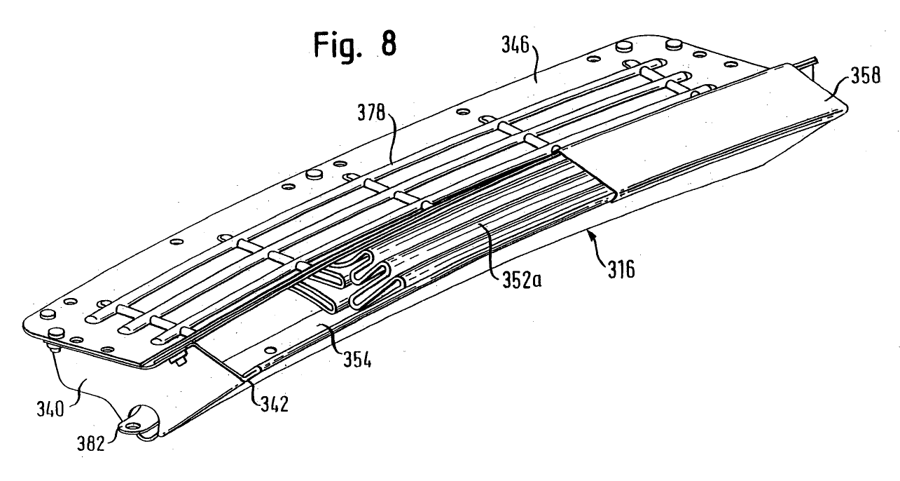

In FIG. 8 a variant of a gas bag module 316′ can be seen in perspective view, which has a complete housing 340′ with its own second ejection channel wall 346′.

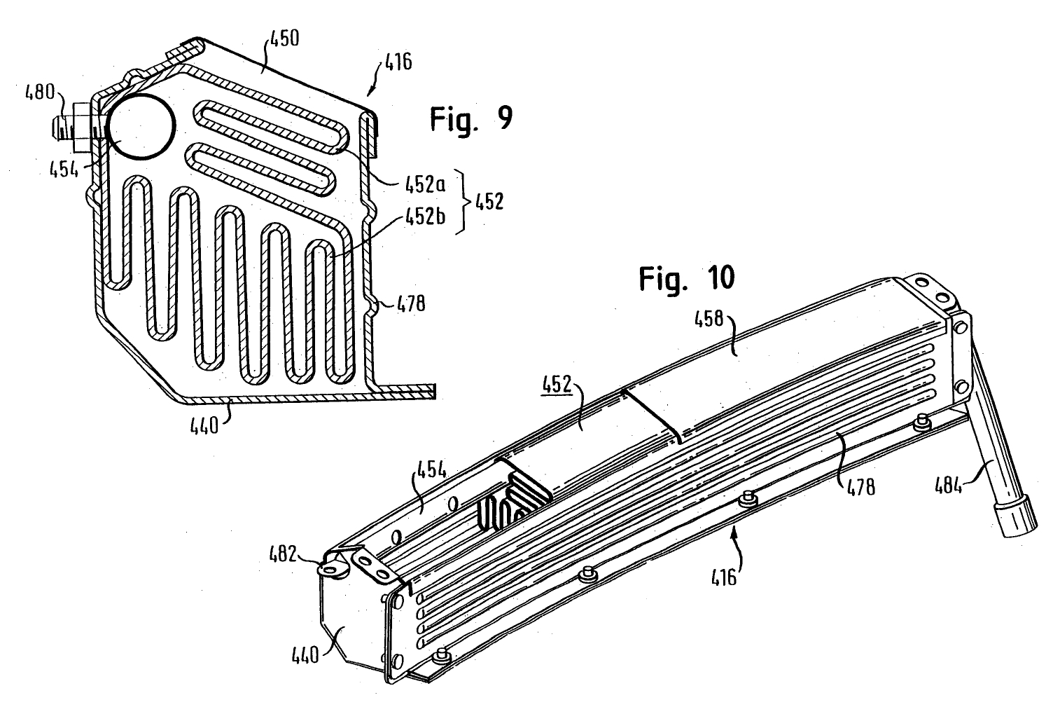

FIGS. 9 and 10 show a gas bag module 416 with a very compact pentagonal cross-section which with a given gas bag volume manages with a low material expenditure for the housing 440 and therefore also offers a high saving with regard to weight and cost.

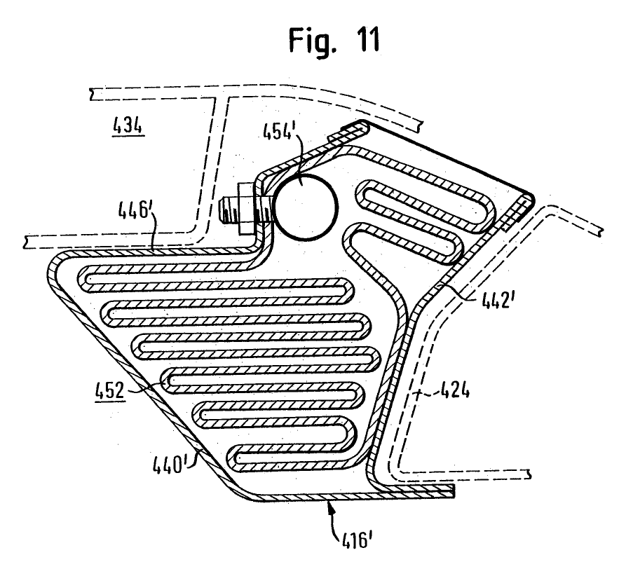

In FIG. 11 a further variant of a housing cross-section can be seen, in which the ejection channel walls 442′, 446′ can be adapted to the contours for example of frame support 424 and ventilation channel 434.

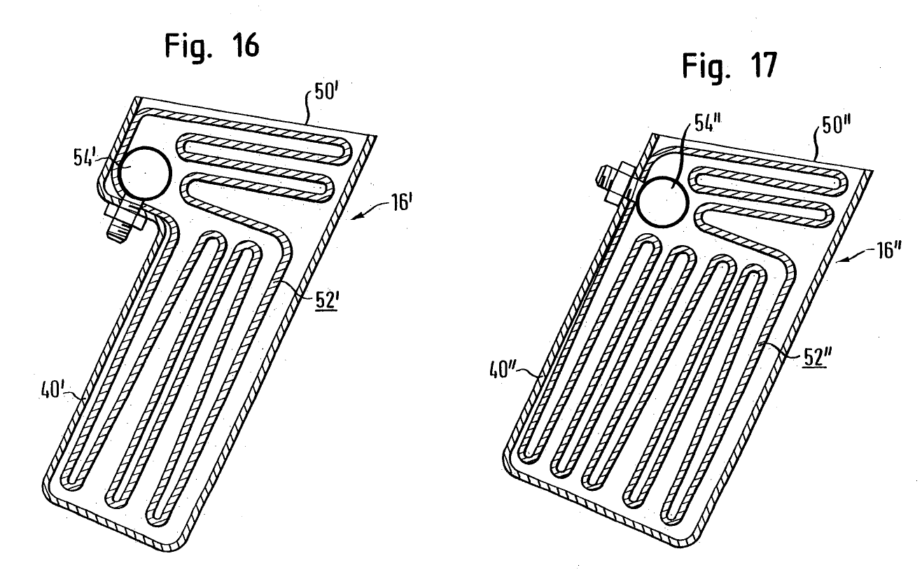

In FIGS. 16 and 17, variants of gas bag modules having various simple cross-sectional shapes are shown.

The gas bag modules of all the described embodiments of the invention can, of course, be constructed both for the driver's and for the passenger's sides. The gas lances of the driver's and passenger's modules can be connected here with one shared gas generator, as is shown for example in FIG. 12, or one separate gas generator each can be provided for the driver's and passenger's sides.

The specific spreading of the gas bag 52 can be further influenced by the shape and arrangement of the outflow openings 56 in the gas lance 54, as illustrated in FIGS. 12 to 15. Firstly, through the arrangement of the outflow openings 56 at the ends of the gas lance 54, or in that the cross-sections of the outflow openings 56 in these regions are constructed so as to to be larger than in the center, it can be achieved that the gas bag 52 spreads out more quickly in the side regions. This is indicated in FIG. 12 by the various spreading phases a to d of the gas bag 52. Such a spreading of the gas bag 52 is particularly advantageous when the vehicle occupant 20 is not in an optimum sitting position.

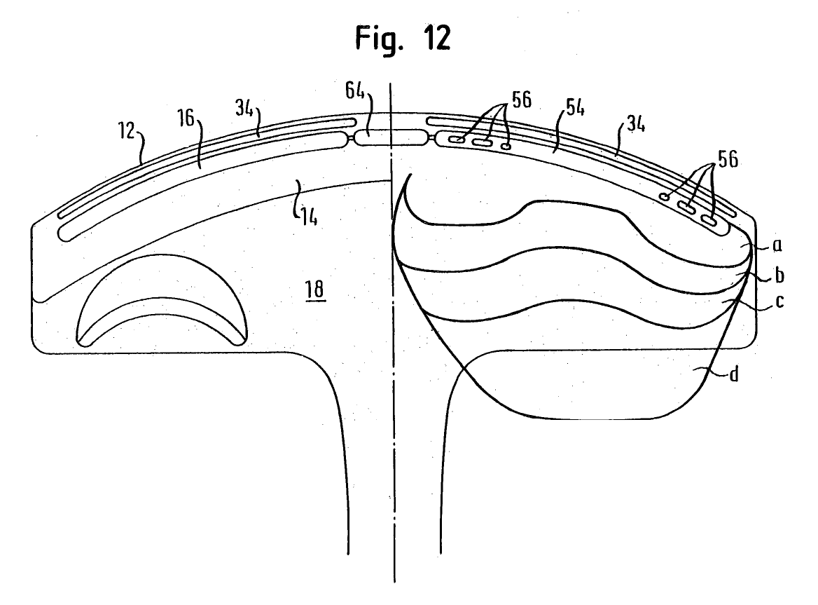

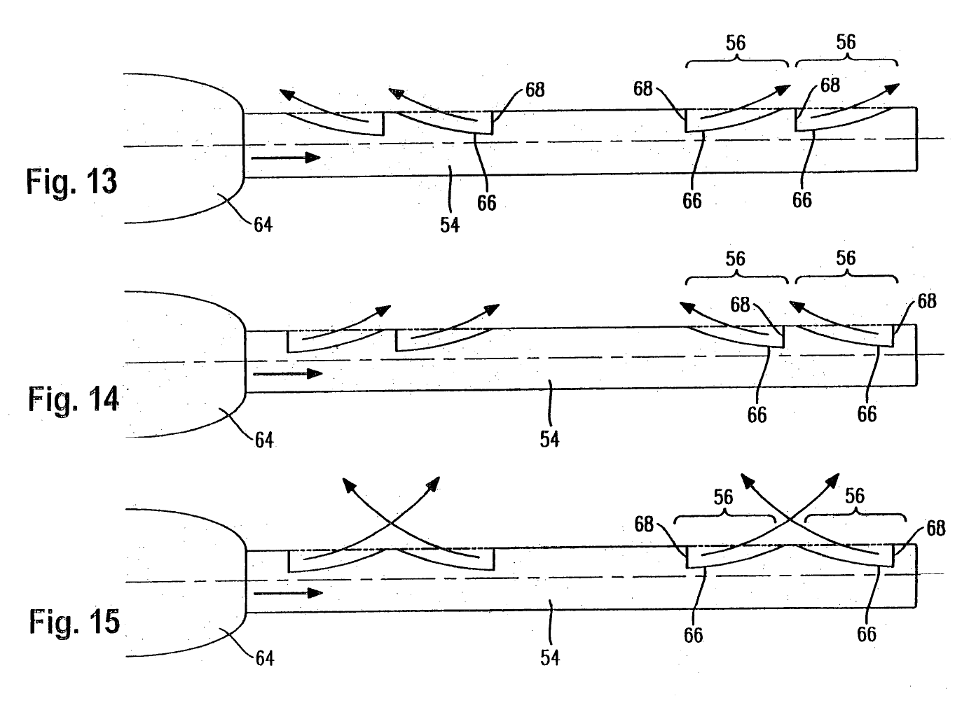

Secondly, the outflow openings 56 in the gas lance 54 can be constructed in an advantageous manner in the form of gill-like indentations 66. In FIGS. 13 to 15 such outflow openings 56 are illustrated. They consist of indentations 66 pressed into the gas lance, of which an end lying in longitudinal direction is punched in and therefore forms an opening 68 to the interior of the tube. Through the gill-like indentations 66, the outflow direction of the gas from the gas lance 54 is substantially given, as is indicated by the arrows in FIGS. 13 to 15. Therefore, the outflowing gas can be directed to the ends (FIG. 13) or to the center (FIG. 14) of the gas lance 54 or swirled at the outflow openings 56 (FIG. 15).

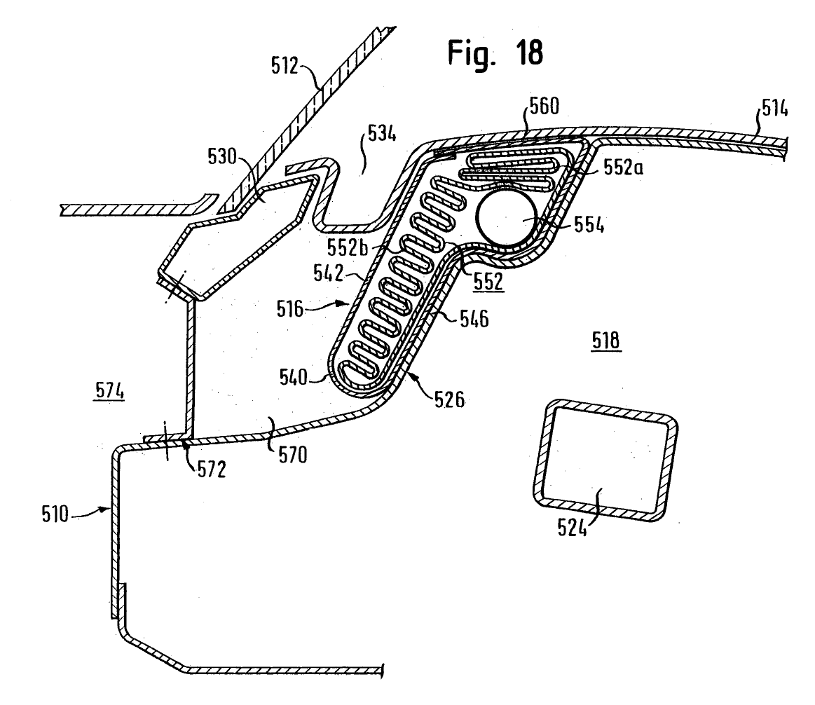

A further embodiment of an assembly according to the invention is shown in FIG. 18, in which reference numbers increased by 500 are used for components which are already known. In this embodiment, the splashboard 526 extends into the vehicle interior 518 up to the instrument panel 514. Between the pane fixture 530 and the splashboard 526 there is an intermediate space 570 which receives the gas bag module 516. The gas bag module 516 is not fastened to the pane fixture 530 or to a frame part 524 as in the preceding embodiments, but rather to the splashboard 526 and namely on the side facing away from the vehicle interior 518, whereas the ventilation channel 534 is situated between the pane fixture 30 and the gas bag module 516. Here, the splashboard 526 can also form the second ejection channel wall 546 for the gas bag module 516. The intermediate space 570 is closed off towards the engine compartment 574 by a moisture protection wall 572 which is fastened to the splashboard 526 and to the pane fixture 530.

This embodiment offers the advantage that the gas bag module 516 can be installed from the direction of the engine compartment 574. This possibility for installation is particularly advantageous with regard to the usually very bulky combined driver and passenger modules.

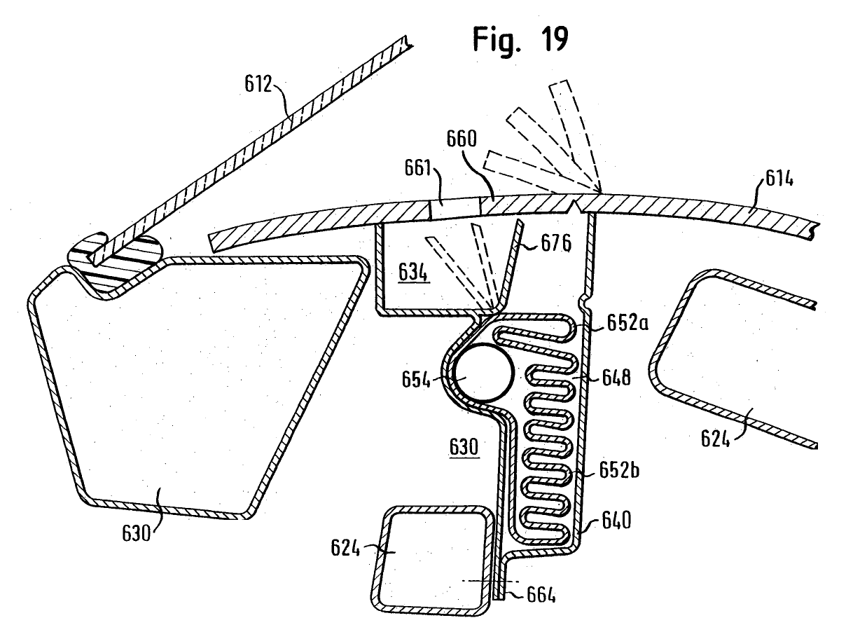

In FIG. 19 there is shown an assembly in accordance with a seventh embodiment. In this embodiment, the housing 640 is constructed in one piece with the ventilation channel 634 and namely suspended therebeneath in the vicinity of the pane fixture 630. The housing 640 is arranged with the fastening section 644 on the frame support 624. The ejection channel 648 is constructed here so as to lie underneath the covering 660, a separation flap 676 being provided to delimit the ventilation channel 634. This flap 676 is so elastic that it yields slightly on unfolding of the gas bag 652, so that the ejection channel 648 widens. In this way, the ventilation opening 661 of the ventilation channel 634 can also be used for the emergence of the gas bag 652.

In FIGS. 20 and 21 a type of construction of a gas bag module is illustrated, in which a gas generator 164 is detachably connected by a connecting clip 186 with the gas lance 154′. Here, the connecting clip 186 embraces the tubular gas generator 164 in the region of its outflow openings 188 which are arranged on a constriction 190. The connecting clip 186 is provided with a connection piece 194 to which the connecting tube 184′ is joined. The connecting clip 186 can be firmly clamped on the periphery of the gas generator 164 in the manner of a tube clamp with screws 192. In this way, a simple installation of the gas generator 164 and, if necessary, a rapid exchange are possible.

All the described embodiments lead to a spreading front of the gas bag having a large area from the outset. This, in combination with the maximum distance from the vehicle occupant, causes the energy of the gas bag to be reduced on unfolding, particularly in the central region of the gas bag, and therefore the stress of a vehicle occupant who is not in an optimum sitting position, to be reduced.

With a gas bag volume of 110 to 140 litres, a length of at least 260 to over 480 mm with a width of 50 to 90 mm and a height of 70 to 110 mm has proved to be advantageous for the dimensions of the gas bag modules of the assemblies according to the invention.

1. An assembly consisting of a gas bag module (16; 16′; 116; 216; 316; 416; 516; 616) and a vehicle body part (10; 510) including a ventilation channel (34; 134; 234; 334; 434; 534; 634) for ventilating a front windscreen, said ventilation channel being arranged between said front windscreen (12; 112; 212; 312; 412; 512; 612) and said gas bag module, said gas bag module (16; 16′; 116; 216; 316; 416; 516; 616) having a gas bag (52; 52′; 52″; 152; 252; 352; 452; 552; 652) folded to form a gas bag package and a gas lance (54; 54′; 54″; 154; 254; 354; 454; 554; 454″; 654) through which gas can be directed into said gas bag, said gas bag module having an ejection opening (50; 50′; 50″; 150; 250; 350; 450) through which said gas bag can be ejected on inflation, characterized in that said gas bag package comprises first and second partial packages, of which said first partial package (52a; 152a; 252a; 352a; 452a; 552a; 652a) is arranged closer to said ejection opening, whereas said second partial package (52b; 152b; 252b; 352b; 452b; 552b; 652b) is arranged further away with respect to said ejection opening, and said gas lance (54; 54′; 54″; 154; 154″; 254; 354; 454; 554; 454″; 654) is arranged in said gas bag module such that only said first partial package (52a; 152a; 252a; 352a; 452a; 552a; 652a) is situated between said ejection opening (50; 50′; 50″; 150; 250; 350; 450) and said gas lance.

2. The assembly according to claim 1, characterized in that said first partial package (52a; 152a; 252a; 352a; 452a; 552a; 652a) is smaller than said second partial package (52b; 152b; 252b; 352b; 452b; 552b; 652b).

3. The assembly according to claim 1, characterized in that said first partial package (52a; 152a; 252a; 352a; 452a; 552a; 652a) is folded in a first way and said second package (52b; 152b; 252b; 352b; 452b; 552b; 652b) is folded in a second way.

4. The assembly according to claim 1, characterized in that said gas lance (54; 54′; 54″; 154; 254; 454; 554; 654) is arranged in a vicinity of said ejection opening (50; 50′; 50″; 150; 250; 350; 450).

5. The assembly according to claim 1, characterized in that said gas bag module (216; 316) has a housing (240; 340) with an ejection channel (248; 348) which opens out into said ejection opening (250; 350), said ejection channel (248; 348) being delimited by a first ejection channel wall (242; 342) which is formed by said housing, and by a second ejection channel wall (246; 346) which is formed by said vehicle body part (230; 334).

6. The assembly according to claim 5, characterized in that said second ejection channel wall is formed by a splashboard of said vehicle.

7. The assembly according to claim 5, characterized in that said vehicle body part has a frame support, said second ejection channel wall being formed by said frame support.

8. The assembly according to claim 5, characterized in that said second ejection channel wall (346) is formed by said ventilation channel (334).

9. The assembly according to claim 5, characterized in that said ejection channel (248; 348) is angled with respect to a remainder of said housing (140; 340), so that said gas bag (150; 350) undergoes a change of direction on ejection.

10. The assembly according to claim 9, characterized in that said ejection channel (148; 348) is angled such that said gas bag (150; 350) on ejection is ejected substantially parallel to said front windscreen (112; 312).

11. The assembly according to claim 1, characterized in that said gas lance (54) has ends and a center and is provided with gill-like outflow openings (56).

12. The assembly according to claim 11, characterized in that said gill-like outflow openings (56) are aligned such that gas flowing out from said gas lance (54) flows towards said ends of said gas lance (54).

13. The assembly according to claim 11, characterized in that said gill-like outflow openings (56) are aligned such that gas flowing out from said gas lance (54) flows towards said center of said gas lance (54).

14. The assembly according to claim 11, characterized in that said gill-like outflow openings (56) are aligned such that gas flowing out from said gas lance (54) is swirled.

15. The assembly according to claim 1, characterized in that said gas bag module has separate gas generators for driver's and passenger's sides.

16. The assembly according to claim 1, characterized in that said gas bag module has a common gas generator for driver's and passenger's sides.

17. The assembly according to claim 1, characterized in that a connecting tube (184; 184′; 484) is arranged between said gas lance (154; 154′; 454) and said gas generator (164; 464).

18. The assembly according to claim 11, characterized in that said connecting tube (184) is connected in said center of said gas lance (154′).

19. The assembly according to claim 1, characterized in that said gas generator (164) is connected with said gas lance (154; 154′) by means of a detachable connection (186).

20. The assembly according to claim 11, characterized in that said detachable connection is formed by a connecting clip (186) which embraces said gas generator (164) in a region of said outflow openings (188).

21. The assembly according to claim 1, characterized in that said housing (640) is arranged on said ventilation channel (634).

22. The assembly according to claim 18, characterized in that said housing (640) is constructed in one piece with said ventilation channel (634).

23. The assembly according to claim 1, characterized in that a length of said gas bag module is defined, which is measured along an extent of said gas lance, said length amounting to at least 260 mm.

24. The assembly according to claim 1, characterized in that a length of said gas bag module is defined, which is measured along an extent of said gas lance, said length amounting to at least 480 mm.

25. The assembly according to claim 1, characterized in that a width of said gas bag module is defined, which is measured transversely to a length and substantially parallel to a plane formed through said ejection opening, said width amounting to approximately 50 to 90 mm.

26. The assembly according to claim 1, characterized in that a height of said gas bag module is defined, which is measured transversely to a length and to a width of said gas bag module and amounts to approximately 70 to 110 mm.

27. The assembly according to claim 1, characterized in that said gas bag has a volume of 110-140 litres.
